(19) United States
(12) Patent Application Publication
(10) Pub. No.: US 2007/0115813 A1
(43) Pub. Date: May 24, 2007

(54) Apparatus and method for proportional fair scheduling for multicast service in a communication system

(75) Inventors: Tae-In Hyon, Hwaseong-si (KR); Won-Hyoung Park, Seoul (KR); Young-Yong Kim, Seoul (KR); Kyoung-Ho Sohn, Seoul (KR); Hoon Kim, Seoul (KR); Chung-Ha Koh, Hongseong-gun (KR); Ji-Wan Song, Seoul (KR)

Correspondence Address: THE FARRELL LAW FIRM, P.C., 333 EARLE OVINGTON BOULEVARD, SUITE 701, UNIONDALE, NY, 11553, US

(73) Assignees: SAMSUNG ELECTRONICS CO., LTD., Suwon-si (KR); INDUSTRY-ACADEMIC COOPERATION FOUNDATION YONSEI UNIVERSITY, Seoul (KR)

(21) Appl. No.: 11/603,383

(22) Filed: Nov. 21, 2006

(30) Foreign Application Priority Data
Nov. 21, 2005 (KR) 2005-0111301

(51) Int. Cl. H04L 12/26; H04J 3/26

(52) U.S. Cl. 370/229; 370/432

(57) ABSTRACT

An apparatus and method for Proportional Fair (PF) scheduling for multicast services in a communication system are provided. In the PF scheduling method, a multicast PF metric is calculated over every AMC level provided by the system using the channel status information and average data rates of MSs, and an AMC level maximizing the multicast PF metric is selected as a multicast service rate.

### PRIORITY

This application claims priority under 35 U.S.C. §119 to an application entitled “Apparatus and Method for Proportional Fair Scheduling for Multicast Service in a Communication System” filed in the Korean Intellectual Property Office on Nov. 21, 2005 and assigned Serial No. 2005-111301, the contents of which are incorporated herein by reference.

### BACKGROUND OF THE INVENTION

1. Field of the Invention

The present invention relates generally to a communication system, and in particular, to an apparatus and method for Proportional Fair (PF) scheduling for multicast services.

2. Description of the Related Art

Owing to the growth of the communications industry, communication systems have been developed to provide multicast multimedia services by enabling transmission of a large amount of data such as packet data and circuit data, as well as providing a voice service.

Multicast services supporting multicast multimedia communications include 3^{rd} Generation Partnership Project (3GPP), Multimedia Broadcast/Multicast Service (MBMS) and 3GPP2 BroadCast/MultiCast Service (BCMCS). In a multicast service, one or more transmitters send the same data to one or more particular receivers. That is, when a transmitter sends data, each receiver receives the copy of the data. The transmitter sends the data to receivers that want to receive the data, i.e. a multicast group. From the transmitter's point of view, it just sends one data packet, thus increasing network efficiency and decreasing network congestion. Since the copies of the data are sent to desired hosts, unnecessary data reception is prevented from the receiver's point of view.

Conventionally, a multicast stream is sent at a fixed rate in the multicast service. Hence, only users having channel status that is sufficient to support a multicast data rate can receive multicast data. While it is necessary for group users to receive the same data into a multicast group, they may be placed in different channel statuses. Thus, when an Adaptive Modulation and Coding (AMC) scheme is used, users may support different data rates. In other words, since available data rates are different among the users, data must be sent at a multicast service rate corresponding to a low AMC level among the available data rates so that users can receive multicast data. Therefore, if too many users are grouped into one multicast group, the data rate for the multicast group decreases, thereby reducing the total amount of data transmitted. On the other hand, since a high multicast service rate limits the number of users to decode data successfully, the multicast service is not available to users in a bad channel status scenario. Thus, conventional multicast service cannot be optimally provided according to the channel status distribution of users.

### SUMMARY OF THE INVENTION

An object of the present invention is to substantially solve at least the above problems and/or disadvantages and to provide at least the advantages below. Accordingly, an object of the present invention is to provide an apparatus and method for PF scheduling for multicast services in a communication system.

Another object of the present invention is to provide an apparatus and method for determining a multicast service rate by introducing the concept of PF scheduling that maximizes total user utility in a communication system.

A further object of the present invention is to provide an apparatus and method for adaptively determining an optimal multicast service rate according to the average data rate and channel status of each user.

The above objects are achieved by providing an apparatus and method for PF scheduling for multicast services in a communication system.

According to an aspect of the present invention, in a PF scheduling method for multicast services in a communication system, a multicast PF metric is calculated over every AMC level provided by the system using the channel status information and average data rates of mobile stations (MSs), and an AMC level maximizing the multicast PF metric is selected as a multicast service rate.

According to another aspect of the present invention, in a PF scheduling apparatus for multicast services in a communication system, a scheduler determines a multicast service rate and a multicast group on a frame-by-frame basis based on the average data rates and user AMC of MSs. A message generator encodes a video stream at the multicast service rate and generates a message for transmission in a current frame using the coded data.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a Base Station (BS) in a communication system according to the present invention;

FIG. 2 is a flowchart illustrating a PF scheduling method for multicast services in the BS of the communication system according to the present invention;

FIG. 3 illustrates an exemplary PF scheduling in the BS of the communication system according to the present invention;

FIG. 4 is a graph comparing a multicast PF technique according to the present invention with a conventional fixed-rate multicast technique in terms of overall system performance;

FIG. 5 is a graph comparing the multicast PF technique according to the present invention with the conventional fixed-rate multicast technique in terms of fairness performance for users;

FIG. 6 illustrates a model of reproducing video streams received by multicast scheduling in an MS according to the present invention;

FIG. 7 is a graph comparing the multicast PF technique according to the present invention with the conventional fixed-rate multicast technique in terms of video quality performance; and

FIGS. 8A and 8B are views comparing the multicast PF technique according to the present invention with the conventional fixed-rate multicast technique in terms of image quality.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

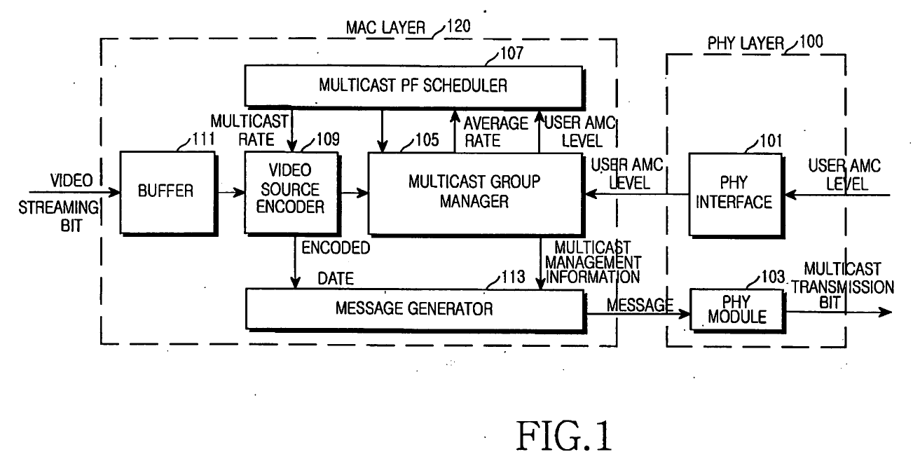

FIG. 1 is a block diagram of a BS in a communication system according to the present invention. The BS includes a PHYsical (PHY) layer 100 and a Medium Access Control (MAC) layer 120. The PHY layer 100 has a PHY interface 101 and a PHY module 103. The MAC layer 120 has a multicast group manager 105, a multicast PF scheduler 107, a video source encoder 109, a buffer 111, and a message generator 113.

Referring to FIG. 1, the PHY interface 101 provides user AMC levels received from MSs to the multicast group manager 105. The user AMC levels indicate data rates at which the MSs can receive data. The PHY module 103 modulates and encodes a message generated from the message generator 113 according to an AMC scheme provided by the system, for transmission over the air.

The multicast group manager 105 manages users that will receive a multicast service (multicast users). For this purpose, the multicast group manager 105 stores the average data rates of the multicast users in a table, updates their average data rates with a multicast service rate determined by the multicast PF scheduler 107 every frame, and places users having average data rates less than or equal to a threshold, i.e. being kept in a bad channel status to outage. Also, the multicast group manager 105 provides the average data rates and AMC levels of the multicast users to the multicast PF scheduler 107 every frame. It receives a multicast service rate determined through scheduling by the multicast PF scheduler 107 and provides the multicast service rate as multicast management information to the message generator 113.

The multicast PF scheduler 107 determines the multicast service rate every frame based on the average data rates and the user AMC levels utilizing an algorithm of the present invention and notifies the multicast group manager 105 and the video source encoder 109 of the multicast service rate.

The video source encoder 109 encodes video streams received from the buffer 111 at the multicast service rate set for a current frame. The buffer 111 stores video streams received from a streaming server and provides the video streams to the video source encoder 109.

The message generator 113 generates a message for transmission in the current frame using the coded data received from the video source encoder 109 and the multicast management information received from the multicast group manager 105, and sends the message to the PHY module 103.

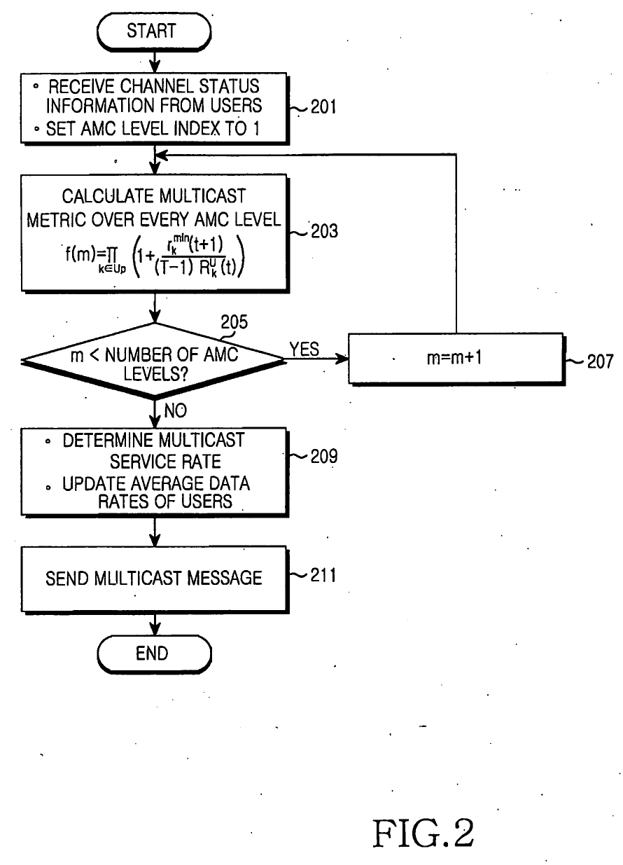

FIG. 2 is a flowchart illustrating a PF scheduling method for multicast services in the BS of the communication system according to the present invention. PF scheduling may be performed on a slot basis, on a frame basis, or on a superframe basis.

Referring to FIG. 2, the BS receives channel status information from MSs to receive a multicast service (multicast MSs) in step 201. Assuming that “M” AMC levels are defined in the system, M multicast service rates are available. The index of an AMC level, “m”, is set to 1. The channel status information is feedback information indicating the AMC levels corresponding to data rates at which the MSs can receive data from the BS, as determined based on their pilot-to-interference ratios (E_{c}/Iₒ). The pilot-to-interference ratios are estimated from pilots on a frame-by-frame basis.

In step 203, the multicast PF scheduler 107 calculates multicast PF metrics based on the channel status information and average data rates of the MSs. The multicast PF metrics are computed based on the definition of the PF. The PF is a technique maximizing the sum of log functions of the average rates of total users, given in Equation (1):

$${\sum }_{k = 1}^{\vert U \vert} log ( {R}_{k} ) \qquad ( 1 )$$

where k represents a user index, |U| represents the total number of users, and R_{K} represents the average rate of the k^{th} user, as updated every slot as in Equation (2):

$${R}_{k} ( t + 1 ) = ( \begin{matrix}\frac{( T - 1 ) {R}_{k} ( t ) + {r}_{k}^{min} ( t + 1 )}{T} , if k ∈ {U}_{S} \\ \frac{( T - 1 ) {R}_{k} ( t )}{T} , elsewhere\end{matrix} ) \qquad ( 2 )$$

where U_{S} represents a multicast group selected by an arbitrary scheduler and rₖ^{min}(t) represents the lowest data rates of multicast users selected by the scheduler. If the k^{th} user belongs to the multicast group, he will receive multicast data at a data rate of rₖ^{min} and thus the current average data rate Rₖ(t+1) of the k^{th} user is computed using the previous average data rate Rₖ(t) and the minimum data rate rₖ^{min}. If the k^{th} user does not belong to the multicast group, he will not receive the multicast service. Hence, Rₖ(t+1) is calculated using Rₖ(t) alone. The reason for using the minimum data rate is that all users of the multicast group can receive data at the lowest of their receivable data rates. T represents a window size to calculate the variable average data rate with. This means that the average data rate is calculated with respect to data received for T slots.

In view of the property of the PF, the following Equation (3) is valid.

$${\sum }_{k ∈ U} log {R}_{k}^{{U}_{P}} ( t + 1 ) \geq {\sum }_{k ∈ U} log {R}_{k}^{{U}_{S}} ( t + 1 ) \qquad ( 3 )$$

where U_{P} represents a multicast user set scheduled for the current slot by the PF scheduler, and U_{S} represents a multicast user set scheduled for the current slot by the arbitrary scheduler. Rₖ^{U}^{_{P}} represents the average data rate of the k^{th} user in the PF scheduling, and Rₖ^{U}^{_{S}} represents the average data rate of the k^{th} user in the arbitrary scheduling.

Equation (3) is simplified to Equation (4):

$${\prod }_{k ∈ U} {R}_{k}^{{U}_{P}} ( t + 1 ) \geq {\prod }_{k ∈ U} {R}_{k}^{{U}_{S}} ( t + 1 ) \qquad ( 4 )$$

The average data rates of users which belong to neither the user set U_{P} nor the user set U_{S} are kept unchanged. Therefore, Equation (5) is as follows:

$${\prod }_{k ∈ {U}_{P} ⋃ {U}_{S}} {R}_{k}^{{U}_{P}} ( t + 1 ) \geq {\prod }_{k ∈ {U}_{P} ⋃ {U}_{S}} {R}_{k}^{{U}_{S}} ( t + 1 ) \\ {\prod }_{k ∈ {U}_{P}} {R}_{k}^{{U}_{P}} ( t + 1 ) \cdot {\prod }_{k ∈ {U}_{S} - {U}_{P}} {R}_{k}^{{U}_{P}} ( t + 1 ) \geq {\prod }_{k ∈ {U}_{S}} {R}_{k}^{{U}_{S}} ( t + 1 ) \cdot {\prod }_{k ∈ {U}_{P} - {U}_{S}} {R}_{k}^{{U}_{S}} ( t + 1 ) \qquad ( 5 )$$

By substituting Equation (2) into Equation (5),

$${\prod }_{k ∈ {U}_{P}} \{ ( 1 - \frac{1}{T} ) \cdot {R}_{k}^{U} ( t ) + \frac{1}{T} \cdot {r}_{k}^{min} ( t + 1 ) \} \cdot {\prod }_{k ∈ {U}_{S} - {U}_{P}} \{ ( 1 - \frac{1}{T} ) \cdot {R}_{k}^{U} ( t ) \} \geq {\prod }_{k ∈ {U}_{S}} \{ ( 1 - \frac{1}{T} ) \cdot {R}_{k}^{U} ( t ) + \frac{1}{T} \cdot {r}_{k}^{min} ( t + 1 ) \} \cdot {\prod }_{k ∈ {U}_{P} - {U}_{S}} \{ ( 1 - \frac{1}{T} ) \cdot {R}_{k}^{U} ( t ) \} \qquad ( 6 )$$

When multiplying both sides by

$${\prod }_{k ∈ {U}_{S} ⋂ {U}_{P}} \{ ( 1 - \frac{1}{T} ) \cdot {R}_{k}^{U} ( t ) \} ,$$

then we have Equation (7):

$${\prod }_{k ∈ {U}_{P}} \{ ( 1 - \frac{1}{T} ) \cdot {R}_{k}^{U} ( t ) + \frac{1}{T} \cdot {r}_{k}^{min} ( t + 1 ) \} \cdot {\prod }_{k ∈ {U}_{S}} \{ ( 1 - \frac{1}{T} ) \cdot {R}_{k}^{U} ( t ) \} \geq {\prod }_{k ∈ {U}_{S}} \{ ( 1 - \frac{1}{T} ) \cdot {R}_{k}^{U} ( t ) + \frac{1}{T} \cdot {r}_{k}^{min} ( t + 1 ) \} \cdot {\prod }_{k ∈ {U}_{P}} \{ ( 1 - \frac{1}{T} ) \cdot {R}_{k}^{U} ( t ) \} \qquad ( 7 )$$

which can be expressed as Equation (8):

$$\frac{{\prod }_{k ∈ {U}_{P}} \{ \begin{matrix}( 1 - \frac{1}{T} ) \cdot \\ {R}_{k}^{U} ( t ) + \frac{1}{T} \cdot \\ {r}_{k}^{min} ( t + 1 )\end{matrix} \}}{{\prod }_{k ∈ {U}_{P}} \{ ( 1 - \frac{1}{T} ) \cdot {R}_{k}^{U} ( t ) \}} \geq \frac{{\prod }_{k ∈ {U}_{S}} \{ \begin{matrix}( 1 - \frac{1}{T} ) \cdot \\ {R}_{k}^{U} ( t ) + \frac{1}{T} \cdot \\ {r}_{k}^{min} ( t + 1 )\end{matrix} \}}{{\prod }_{k ∈ {U}_{S}} \{ ( 1 - \frac{1}{T} ) \cdot {R}_{k}^{U} ( t ) \}} \\ {\prod }_{k ∈ {U}_{P}} ( 1 + \frac{{r}_{k}^{min} ( t + 1 )}{( T - 1 ) {R}_{k}^{U} ( t )} ) \geq {\prod }_{k ∈ {U}_{S}} ( 1 + \frac{{r}_{k}^{min} ( t + 1 )}{( T - 1 ) {R}_{k}^{U} ( t )} ) \qquad ( 8 )$$

Accordingly, the multicast PF metric can be defined, using Equation (8), as Equation (9):

$$f ( m ) = {\prod }_{k ∈ {U}_{P}} ( 1 + \frac{{r}_{k}^{min} ( t + 1 )}{( T - 1 ) {R}_{k}^{U} ( t )} ) , for m = 1 , … , M \qquad ( 9 )$$

where f(m) represents a function for an m^{th} AMC level. The multipath PF metric is calculated over all available AMC levels by substituting them into the multicast service rate rₖ^{min}, also the lowest data rate. The average data rates of serviceable users may vary depending on the data rates of AMC levels applied to Equation (9). An AMC level maximizing f(m) is selected as the AMC level at which the system provides the multicast service, and a multicast scheduling group is made up of users that can receive multicast data at the AMC level.

In step 205 of FIG. 2, the multicast PF scheduler 107 of the BS compares the AMC level index m with the number of available AMC levels, M. If m is less than M, the BS increases m by 1 in step 207 and returns to step 203 where the BS calculates the multicast PF metric over the next AMC level. If m is equal to or larger than M, the multicast PF scheduler 107 selects an AMC level maximizing the multicast PF metric, determining that the multicast PF metric has been computed over every AMC level and then determines the selected AMC level as the multicast service rate rₖ^{min} in step 209. Users reporting good channel quality, enough to support the determined multicast service rate, are grouped into a multicast group and the average data rates of all MSs are changed. The BS then updates the average data rates of the MSs according to Equation (2). If some users are excluded from the multicast service in the current frame, the exclusion is reflected in Rₖ^{U}(t) and the probability of the users receiving the multicast service in the next slot is increased. Since the status of channels of the users changes in every slot, the multicast group is not fixed, even though the multicast service rate is fixed. Scheduling is performed taking into account the status of the channels and average data rates of the users by determining a multicast service rate for every slot by the algorithm of the present invention.

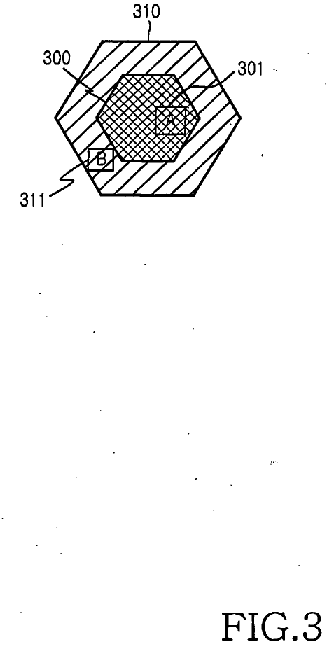

In the illustrated case of FIG. 3, it is assumed that AMC levels of 100, 200 and 300 are available and the window size T is 1000 in a system with multicast MSs 301 and 311 (MS A and MS B, respectively). It is also assumed that MS A has an average data rate of 150 and supports an AMC level of 300 in a high-rate region 300 and MS B has an average data rate of 20 and supports an AMC level of 100 in a low-rate region 310. For the AMC level of 100, both MSs A and B can receive a multicast service and the multicast PF metric is (1+100/(999×150))(1+100/(999×20))=1.0057. For the AMC level of 200, MS A can receive the multicast service and the multicast PF metric is (1+200/(999×150))=1.0013. For the AMC level of 300, MS A can receive the multicast service and the multicast PF metric is (1+300/(999×150))=1.0020. Since the AMC level offering the largest metric value is 100, the BS determines selects the AMC level 100 as the multicast service rate. In this case, both MSs A and B receive the multicast service.

In step 211, the BS encodes a video stream at the multicast service rate, generates a multicast message out of the coded video stream, and sends the multicast message to the multicast group. In this way, the multicast service rate is determined taking into account the average rates and channel status of the users in every slot, thereby ensuring long-term proportional fairness. Then the BS ends the algorithm.

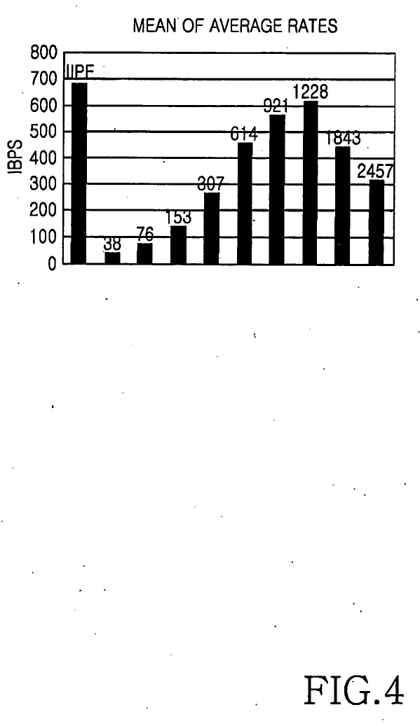

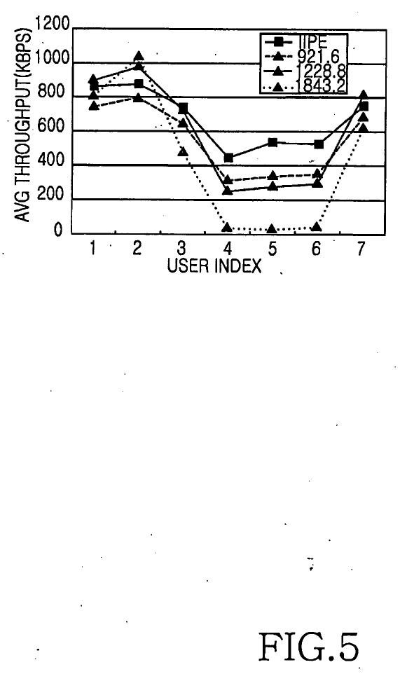

FIGS. 4 and 5 are graphs comparing the multicast PF technique according to the present invention with a conventional fixed-rate multicast technique in terms of throughput performance. While the comparison is carried out in the context of a Code Division Multiple Access 1×Evolution-Data Only (CDMA 1× EV-DO) system, it can be performed in any Time Division Multiple Access (TDMA) system using adaptive AMC. The 1×EV-DO system provides 11 AMC levels ranging from 38.4 kbps to 2457.6 kbps according to the E_{c}/Iₒ values of users. The service area of the system is divided into 19 cells and users are randomly distributed across the cells. It is assumed that a BS is located at the center of each cell, all MSs move commonly at 3 km/h, and only path loss is taken into account for in-cell noise. Other simulation conditions are given in Table 1.

TABLE 1

| Parameter | value | |
|---|---|---|
| Number of cells | 19 | |
| Path loss model | 28.6 + 35log1O(d) dB | |
| Log-normal shadowing | Standard deviation = 8.9 dB | |
| Thermal noise density | −174 | dBm/Hz |
| Carrier frequency | 2 | GHz |
| Terminal antenna gain | −1 | dB |
| Other loss | 10 | dBi |
| Peak PA power in BS | 20 | mW |
| Slot size | 1.67 | ms |

FIG. 4 is a graph comparing the multicast PF technique according to the present invention with the conventional fixed-rate multicast technique in terms of overall system performance. The leftmost bar indicates the performance of the multicast PF scheduling of the present invention, and the other nine bars indicate the performance of the conventional fixed-rate multicast scheduling. In the conventional technology, performance increases with the multicast service rate as far as the multicast service rate is 1228.8 kbps or lower, but it decreases at a multicast service rate above 1228.8 kbps because there is a shortage of users capable of handling a high-level AMC mode. On the contrary, the multicast PF scheduling of the present invention services users in a channel status equal to or better than an acceptable level, and services users in a bad channel status, waiting until their channel status becomes good. Therefore, it provides better performance than the maximum performance the conventional fixed-rate multicast scheduling can offer with respect to the average of average data rates.

FIG. 5 is a graph comparing the multicast PF technique according to the present invention with the conventional fixed-rate multicast technique in terms of fairness performance for users. Referring to FIG. 5, in a multicast scheduling scheme using a fixed multicast service rate of 1228.8 kbps, two users close to a BS have high performance, while users at a cell boundary scarcely receive multicast data because the multicast service rate is too high for their channel statuses. Thus, the fixed-rate multicast scheduling provides high performance at 1288.8 kbps without ensuring fairness for all users. On the other hand, the multicast PF scheduling of the present invention guarantees fairness across users in a good channel status and in a bad channel status, alike because the PF metric is calculated, reflecting the average data rate of each user and the amount of multicast data to be sent to the user.

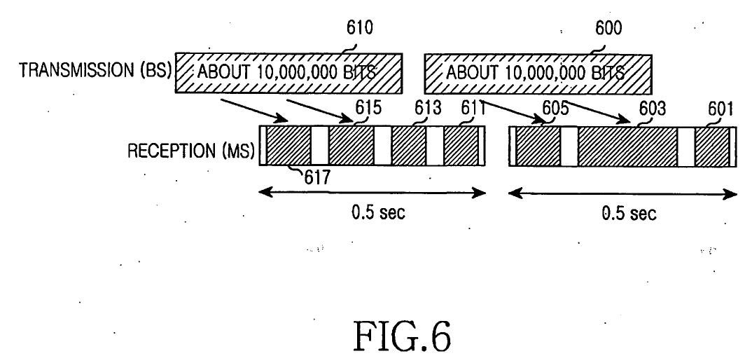

FIG. 6 illustrates a model of reproducing video streams received by multicast scheduling in an MS according to the present invention. Video streams are reproduced each 0.5 seconds (16 video frames). The Base Station determines a service rate according to the present invention at each slot (601, 603, 605) in a first 0.5 second interval for about 10,000.000 bits (600) and determines a service rate at each slot (611, 613, 615, 617) in a second 0.5 second interval for about 10,000.000 bits (610). The service rate may be a variable rate or a fixed rate.

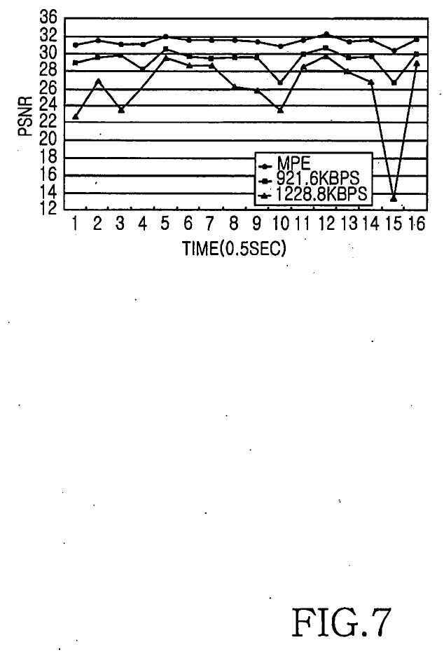

FIG. 7 is a graph comparing the multicast PF technique according to the present invention with the conventional fixed-rate multicast technique in terms of video quality performance.

A BS determines a multicast service rate using the algorithm of the present invention or a conventional algorithm in every slot and sends data of a size corresponding to the multicast service rate to an MS. However, since a multicast group changes according to the time-variant channel status of the MS, the MS cannot receive all transmission video streams. Therefore, the MS collects bits received for 0.5 or 1 second and reproduces the bits to a video image through decoding. As more bits are received for a given time, they can be reproduced at a higher rate and thus Peak Signal-to-Noise Ratio (PSNR) increases. A criterion for measuring video quality in video coding is a parameter indicating a quality difference with respect to the original image, i.e. PSNR. When the number of bits received for a predetermined time (i.e. average data rate) varies greatly, the video quality also changes and user-felt service quality decreases. Accordingly, the PSNR variation as well as the PSNR must be considered in performance evaluation. That is, as the PSNR variation of the image is not high, the user can receive the streaming service stably.

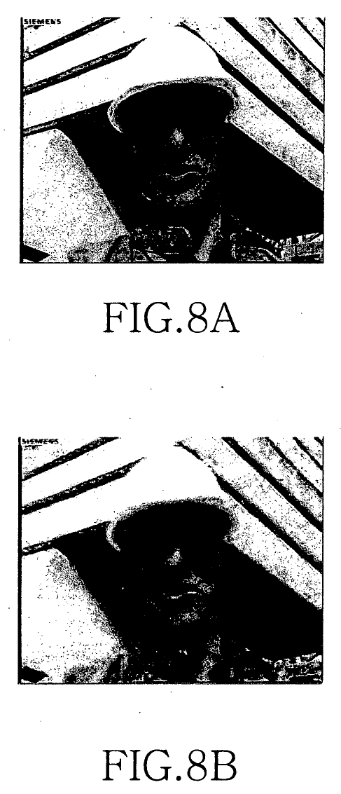

Referring to FIG. 7, it is noted that the inventive multicast PF scheduling provides higher PSNR and lower PSNR variation, which implies that a streaming service is supported for users more stably. A very high quality image is presented at a 40-dB or above PSNR, a high quality image at a PSNR between 30 and 40 dB, and a low quality image at a PSNR between 20 and 30 dB. Referring to FIGS. 8A and 8B, it can be seen that the multicast PF scheduling (FIG. 8A) offers better image quality than the conventional fixed-rate multicast scheduling (FIG. 8B).

In accordance with the present invention as described above, an optimum multicast rate and an optimum multicast group are selected adaptively according to the average data rates and channel statuses of users in a communication system supporting multicast service. Since an optimum multicast service rate is determined according to the channel status distribution of the users, high performance can be achieved with respect to the average of the averages data rates of the users and fairness is ensured across the users in good and bad channel statuses alike. Also, when the multicast data provided by the multicast PF scheduling is reproduced, the PSNR of the reproduced image is high and the variation of the PSNR is low. As a consequence, a stable streaming service can be provided to the users.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A Proportional Fair (PF) scheduling method for multicast services in a communication system, comprising the steps of:
calculating a multicast PF metric over Adaptive Modulating and Coding (AMC) levels provided by the system using the channel status information and data rates of Mobile Stations (MSs); and
selecting an AMC level maximizing the multicast PF metric as a multicast service rate.

2. The PF scheduling method of claim 1, further comprising making up a multicast group with users which can receive multicast data at the multicast service rate.

3. The PF scheduling method of claim 1, wherein the multicast PF metric is expressed as
$$f ( m ) = {\prod }_{k ∈ {U}_{P}} ( 1 + \frac{{r}_{k}^{min} ( t + 1 )}{( T - 1 ) {R}_{k}^{U} ( t )} ) , for m = 1 , … , M$$
where k represents a user index, Uₚ represents a multicast group scheduled for a current slot by a PF scheduler, Rₖ^{U}(t) represents the average data rate of a k^{th} user, T is a window size, and rₖ^{min} represents a lowest of data rates of users selected by the PF scheduler, into which the AMC level substitutes.

4. The PF scheduling method of claim 1, further comprising updating the average data rates of the MSs.

5. The PF scheduling method of claim 4, wherein the updating step comprises updating the average data rates by
$${R}_{k} ( t + 1 ) = ( \begin{matrix}\frac{( T - 1 ) {R}_{k} ( t ) + {r}_{k}^{min} ( t + 1 )}{T} , if k ∈ {U}_{S} \\ \frac{( T - 1 ) {R}_{k} ( t )}{T} , elsewhere\end{matrix} )$$
where k is the user index, Rₖ represents the average data rate of the k^{th} user, T is the window size, and rₖ^{min} represents the lowest data rates of the users selected by the PF scheduler.

6. A Proportional Fair (PF) scheduling apparatus for multicast services in a communication system, comprising:
a scheduler for determining a multicast service rate based on data rates and user Adaptive Modulating and Coding (AMC) levels of Mobile Stations (MSs); and
a message generator for encoding a video stream at the multicast service rate and generating a message for transmission in a current frame using the coded video stream.

7. The PF scheduling apparatus of claim 6, further comprising a multicast group manager for storing the average data rates of the MSs in a table, updating the average data rates on a frame-by-frame basis, and providing the updated average data rates and channel status information received from the MSs to the scheduler.

8. A method for selecting a multicast service rate in a communication system, comprising the steps of:
calculating a multicast PF (Proportional Fair) metric over Adaptive Modulating and Coding (AMC) levels; and
selecting an AMC level maximizing the multicast PF metric as a multicast service rate.

9. The method of claim 8, further comprising making up a multicast group for users which can receive multicast data at the multicast service rate.

10. The method of claim 8, wherein the multicast PF metric is expressed as
$$f ( m ) = {\prod }_{k ∈ {U}_{P}} ( 1 + \frac{{r}_{k}^{min} ( t + 1 )}{( T - 1 ) {R}_{k}^{U} ( t )} ) , for m = 1 , … , M$$
where k represents a user index, Uₚ represents a multicast group scheduled for a current slot by a PF scheduler, Rₖ^{U}(t) represents the average data rate of a k^{th} user, T is a window size, and rₖ^{min} represents a lowest of data rates of users selected by the PF scheduler, into which the AMC level substitutes.

11. The method of claim 8, further calculating a multicast PF metric is performed using the channel status information and average data rate of Mobile Station (MS).

12. The method of claim 11, further comprising updating the average data rates of the MSs.

13. The method of claim 12, wherein the updating step comprises updating the average data rates by
$${R}_{k} ( t + 1 ) = ( \begin{matrix}\frac{( T - 1 ) {R}_{k} ( t ) + {r}_{k}^{min} ( t + 1 )}{T} , if k ∈ {U}_{S} \\ \frac{( T - 1 ) {R}_{k} ( t )}{T} , elsewhere\end{matrix} )$$
where k is the user index, Rₖ represents the average data rate of the k^{th} user, T is the window size, and rₖ^{min} represents the lowest data rates of the users selected by the PF scheduler.

14. A communication system including a Proportional Fair (PF) scheduling apparatus for multicast services, the apparatus comprising:
a scheduler for determining a multicast service rate based on data rates and user Adaptive Modulating and Coding (AMC) levels of Mobile Stations (MSs); and
a message generator for encoding a video stream at the multicast service rate and generating a message for transmission in a current frame using the coded video stream.

15. The communication system of claim 14, further comprising a multicast group manager for storing the average data rates of the MSs in a table, updating the average data rates on a frame-by-frame basis, and providing the updated average data rates and channel status information received from the MSs to the scheduler.

16. A communication system for multicast services comprising:
a scheduler for determining a multicast service rate by calculating multicast PF (Proportional Fair) metric over Adaptive Modulating and Coding (AMC) levels of Mobile Stations (MSs); and
a message generator for encoding a video stream at the multicast service rate and generating a message for transmission in a current frame using the coded video stream.

17. The communication system of claim 16, wherein the calculation of multicast PF metric is expressed as
$$f ( m ) = {\prod }_{k ∈ {U}_{P}} ( 1 + \frac{{r}_{k}^{min} ( t + 1 )}{( T - 1 ) {R}_{k}^{U} ( t )} ) , for m = 1 , … , M$$
where k represents a user index, Uₚ represents a multicast group scheduled for a current slot by a PF scheduler, Rₖ^{U}(t) represents the average data rate of a k^{th} user, T is a window size, and rₖ^{min} represents a lowest of data rates of users selected by the PF scheduler, into which the AMC level substitutes.

18. The communication system of claim 17, further calculating a multicast PF metric is performed using the channel status information and average data rate of Mobile Station (MS).

19. The communication system of claim 18, further comprising updating the average data rates of the MSs.

20. The communication system of claim 19, wherein the updating step comprises updating the average data rates by
$${R}_{k} ( t + 1 ) = ( \begin{matrix}\frac{( T - 1 ) {R}_{k} ( t ) + {r}_{k}^{min} ( t + 1 )}{T} , if k ∈ {U}_{S} \\ \frac{( T - 1 ) {R}_{k} ( t )}{T} , elsewhere\end{matrix} )$$
where k is the user index, Rₖ represents the average data rate of the k^{th} user, T is the window size, and rₖ^{min} represents the lowest data rates of the users selected by the PF scheduler.
